(19) United States
(12) Patent Application Publication
(10) Pub. No.: US 2010/0091968 A1
(43) Pub. Date: Apr. 15, 2010

(54) METHODS, SYSTEMS, AND COMPUTER PROGRAM PRODUCTS FOR ROUTING COMMUNICATIONS ACCORDING TO LOYALTY PROGRAM PROFILES

(75) Inventor: Dylan Reid, Atlanta, GA (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/249,461

(22) Filed: Oct. 10, 2008

(51) Int. Cl. H04M 3/42

(52) U.S. Cl. 379/207.02

(57) ABSTRACT

A method of routing communications according to a loyalty program can include receiving guest information upon checking-in at a location associated with a loyalty program indicating an identifier for communications to a guest while checked-in via the location and associating the identifier for communications to the guest with a guest profile upon receiving the guest information upon checking-in.

### BACKGROUND

The present invention generally relates to the field of electronic communications.

Loyalty programs can be popular with travelers who utilize services, such as hotels, airlines, rail carriers, or other types of services on a repeated basis. For example, business travelers may join a loyalty program (sometimes referred to as a hospitality program) associated with a certain hotel at which they frequently stay to earn membership points. After accumulating a certain number of membership points, the member may be eligible for complimentary upgrades, free services, etc. The businesses that offer such loyalty programs may gain the benefit of the members' loyalty by providing these preferred services to the members and may also gain incite into the members' preferences so that the business can offer improved and/or additional services to the program members.

### SUMMARY

According to exemplary embodiments methods, systems, and computer program products are provided for routing communications, such as calls/messages, according to loyalty program profiles. Pursuant to these embodiments, a method of routing communications according to a loyalty program can include receiving guest information upon checking-in at a location associated with a loyalty program indicating an identifier for communications to a guest while checked-in via the location and associating the identifier for communications to the guest with a guest profile upon receiving the guest information upon checking-in.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram that illustrates guest check-in at a loyalty program location resulting in associating guest information with an identifier for communications with the guest and routing according to an established guest profile in some embodiments.

FIG. 2 is a schematic representation of a guest profile used for routing communications to the guest in some embodiments.

FIG. 3 is a block diagram that illustrates routing of communications using a call/message router according to a guest profile in some embodiments.

FIG. 4 is a block diagram that illustrates routing of communications using a call/message router according to a guest profile in some embodiments.

FIG. 5 is a flowchart that illustrates operations including guest check-in resulting in association of an identifier for communication with a guest profile in routing of communications according thereto in some embodiments.

FIG. 6 is a block diagram that illustrates systems providing operations of methods and/or computer program products for routing of communications according to a guest profile in some embodiments.

### DESCRIPTION OF EMBODIMENTS

Exemplary embodiments are described more fully hereinafter with reference to the accompanying figures, in which the exemplary embodiments are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

Exemplary embodiments are described below with reference to diagrams (such as schematic illustrations) and/or operational illustrations of methods, devices, and computer program products according to embodiments of the invention. It is to be understood that the functions/acts noted in the figures may occur out of the order noted in the operational illustrations. For example, two elements shown in succession may in fact be executed substantially concurrently or the elements may sometimes be executed in the reverse order, depending upon the functionality/acts involved.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The computer program code may be provided to a processor of a general purpose computer, special purpose computer, or other programmable data processing apparatus as instructions to produce a machine, such that the instructions, which execute via the processor of the computer or other programmable data processing apparatus, create means for implementing the functions specified in the illustrations.

The computer code may be stored in a computer-readable memory that can direct a computer or other programmable data processing apparatus to function in a particular manner, such that the instructions stored in the computer-readable memory produce an article of manufacture including instruction means which implement the function specified in the illustrations.

It will be understood that at least a portion of the routing of messages can use communications provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4.

The communications used for messages may be provided using an Internet Protocol (IP) Multimedia Subsystem (IMS). IMS can utilize a packet switched domain (such as the Internet) to transport multimedia signaling and bearer traffic. The message forwarding may be provided, for example, via a Universal Mobile Telecommunication System (UMTS) to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that messages can be provided via a TCP/IP Session Initiation Protocol (SIP) message, a SS7 (Signaling System 7) message, a common channel signaling message, an in-band signaling message, a Short Message Service (SMS) message, an Enhanced Message Service (EMS) message, a Multimedia Message Service (MMS) message, and/or Smartmessaging™ message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateway.”

It will be understood that although some exemplary embodiments herein describe routing of calls/messages according to a profile, some embodiments can provide for routing of any communications according to a profile.

As described hereinbelow in greater detail, in some embodiments users can become members of a loyalty program to set up a guest profile that can be activated upon check-in via a location(s) associated with the loyalty program. The guest profile can specify how communications directed to the guest are to be routed while the guest is checked-in via a particular loyalty location. Moreover, in some embodiments, communications can be routed according to the guest profile while the guest is checked in, but not necessarily physically remaining at the location where the guest checked-in. For example, at one location the guest profile may specify that all calls/messages directed to the guest are to be re-directed to the guest's mobile phone number.

The guest profile can also specify other ways that the guest may be contacted while checked-in. For example, the guest profile may specify that the room number should be tried first, whereupon if the call goes unanswered after a certain number of rings, the call/message is then re-directed to the guest's mobile phone, which if unanswered after a specified number of rings, is redirected to another number or address specified in the guest profile. Accordingly, the guest profile can be used to customize communications for the guest while the guest is checked in at the location. This type of customized communication may improve guest satisfaction which may, in turn, increase the loyalty of the guest to stay more frequently at locations associated with the loyalty program.

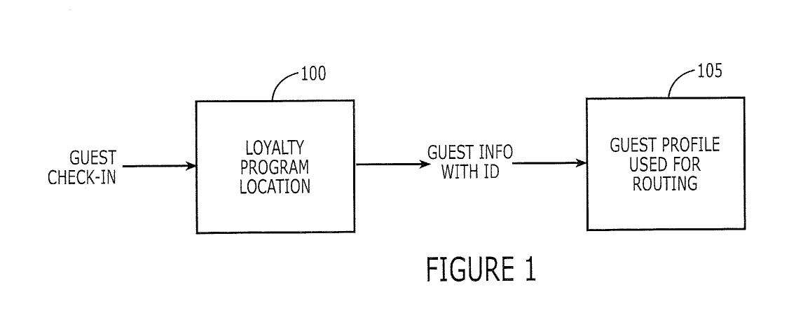

FIG. 1 is a block diagram that illustrates guest check-in to a loyalty program location 100 that provides guest information including an identifier for communications to the guest (associated with a guest profile 105) in some embodiments. According to FIG. 1, when a guest checks in to the loyalty program location 100, the staff at the location 100 performs the typical check-in procedures which generates a message to the guest profile 105 that can include the guest information with the identifier that is to be used for communications with the guest while the guest is checked in at the location 100.

The identifier for communications is associated with the guest profile 105 that was previously established with a loyalty program administrator. For example, the loyalty program administrator may operate a server or web site that provides an interface for users to register with the loyalty program or for members to update their information or preferences, such as their currently defined profiles. It will be understood that the loyalty program administrator may be different and separate from systems and administrators that maintain the guest profiles. For example, in some embodiments, the member information may be linked to the associated guest profile(s) for the member, which are maintained on a separate system.

It will be understood that while the guest is checked in at the location 100, calls/messages can be re-directed or routed according to the guest profile 105. For example, the identifier can be associated with an extension number for a particular room in which the guest is staying at the location 100. Therefore, rather than route a call/message directly to the respective terminal located in the room, instead the call/message can be routed according to the guest profile 105.

It will be understood that the loyalty program location 100 shown in FIG. 1 can represent a plurality of loyalty program locations, each of which may be identified in the guest profile 105. For example, the guest profile 105 may be initiated by specifying several different locations 100 at which the guest frequently stays. Furthermore, the details included in the guest profile 105 associated with each of the respective locations 100 may be different. For example, a first loyalty program location 100 may be included in the guest information as provided with the identifier to the guest profile 105. The guest profile 105 may thereby activate a particular portion of the profile that is associated with the particular location 100 at which the guest is checked in. Further, the guest profile 105 may specify different routing for different loyalty program locations 100. Accordingly, routing of calls/messages may be handled differently depending on which loyalty program location 100 the guest is currently checked into. When the guest finally checks out of the loyalty location 100 the staff performs the typical check out procedure which entails the transmission of a message to the administrator of the guest profile 105 that deactivates the guest profile 105.

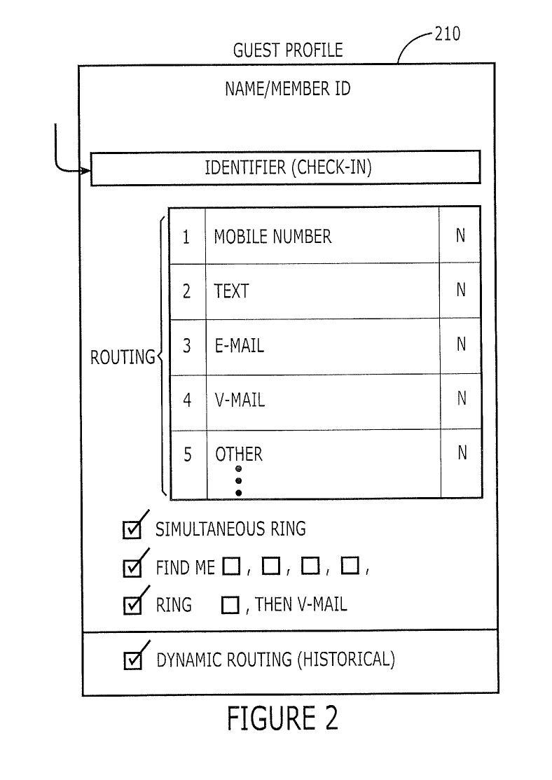

FIG. 2 is a schematic representation of a guest profile 210 that can be setup and/or modified by a member of the loyalty program in some embodiments. In particular, the guest profile 210 can be initiated by a member via a website or portal that is controlled by a loyalty program administrator, which may be separate from the organizations, such as hotels, that manage and operate the locations associated with the loyalty program. Accordingly, before staying at a loyalty program location 100, a prospective member may visit the loyalty program portal or website and register with the loyalty program to become a member. During setup of the profile 210, the member can also specify preferred routing information that is to be used when the member is checked into a particular loyalty program location 100. Accordingly, it will be understood that the information shown in the guest profile 210 can be duplicated for a number of loyalty program locations 100 but is shown in a simplified form to represent a generic profile that could be used for any loyalty program location 100.

The guest profile 210 specifies an identifier associated with the guest profile 210, which is assigned during check-in. It will be understood that the identifier shown in the guest profile 210 may be only logically associated with the guest profile 210 and may not actually be physically included in the same record as the guest profile 210. Rather, the identifier is shown as part of the guest profile 210 in FIG. 2 only to convey that the routing and other information shown in the guest profile 210 which is associated with the identifier for communications is to be associated with the guest when checked in at the loyalty program location 100.

Still referring to FIG. 2, the routing information specified by the member can include a mobile telephone number, a text message field, an e-mail address, a voice mail system of server, and/or other channels that can be used to communicate with the member while checked in to the location 100. For example, the mobile number may specify the member's mobile telephone number to which voice communications are to be routed while the member is checked in to the location 100. Further, the text field may specify a number that text messages (rather than voice calls) are to routed to when the guest is checked in. In some embodiments, the routing information may specify an e-mail address that is to be used for e-mail directed to the guest while checked into location 100. The routing information may also specify a voicemail flag that directs incoming calls/messages directly to the guest's voicemail that may be associated, for example, with the member's mobile telephone number.

In operation, an incoming call/message that is directed to the guest's room number may, instead, be re-routed according to the routing information in the guest profile 210 described above. For example, the routing information may specify the member's mobile number so that incoming calls are routed from the telephone in the member's room to the member's mobile telephone. In some embodiments, a text field may specify that only text messages may be re-directed to the member's mobile telephone number. Alternatively, the text field can specify and address or number to which any incoming text message is to be routed.

If an e-mail address is provided as part of the routing information, incoming messages may be routed to the specified address. Alternatively, the e-mail field may specify that only e-mail may be routed to the member's mobile telephone number. If the voice mail field is set, incoming calls-messages may be re-directed from the member's room directly to the member's voice mail associated with the member's mobile telephone number.

Further, in some embodiments, selected fields (N) in the routing information may also specify an interval after which calls/messages are routed to still another alternative channel for communication with the guest. For example, the interval associated with the guest's mobile telephone number may specify that after a certain number of rings to the guest's mobile phone number, the call/message can be routed to the voicemail specified in the profile 210 or other number specified by the guest profile 210.

Still referring to FIG. 2, the guest profile 210 can also specify further details regarding the routing of calls/messages to the guest. For example, the guest profile 210 can specify a simultaneous ring function where each of the numbers specified in the guest profile (as well as the number of the telephone in the guest's room) can each be rung simultaneously whereupon the call/message is routed to whichever device is answered first. For example, if the simultaneous ring box shown in the guest profile 210 is checked, the guest's mobile phone and room telephone can both ring simultaneously. If the guest is in the room and answers the room telephone first, the call is directed to the telephone in the room. Alternatively, if the guest is in the lobby and accepts the call using the mobile phone, the call is routed to the mobile.

As further shown in FIG. 2, the “Find me” box can specify that each of the numbers specified in the guest profile 210 can be tried sequentially until the guest answers or until the call is directed to the guest's voice mail. Furthermore, the numbers specified by the guest profile 210 can be listed in the order in which those numbers will be tried. For example, the mobile phone number may be specified as the first member to be tried whereupon if the call is unanswered, the next member specified in the list is tried and so on.

Still referring to FIG. 2, a customized routing field can specify that a particular number can be tried first whereupon if the call is not answered after a specified number of rings, the call is directed to voice mail. In still further embodiments, a dynamic routing field can specify that the order in which a call is to routed to different numbers can be modified based on historical performance. For example, the performance of a guest profile 210 can be monitored to determine that in most past situations, the call has been successfully routed to a certain number specified by the guest profile. Accordingly, the system which administers the guest profile 210 may dynamically modify the order in which numbers included in the routing information in the guest profile 210 can be tried. Furthermore, the order in which the routing takes place can be dependent upon the location 100 at which the guest is checked in. For example, at a first hotel, it may be historically evident that the guest is typically reached at the number specified third in the list of routing. Accordingly, the dynamic routing may route calls at that location so that the third number is actually tried first. In contrast, if it is historically evident that at a second location the second specified number is typically the number at which the guest is reached, the dynamic routing may modify the routing so that the second number is tried first at the second location. Moreover, the historical dynamic routing for each of the locations may be maintained by the profile 210.

In some embodiments, international travelers who are guests at hotels may be provided with a SIM card for a mobile communications device, such as a GSM or CDMA wireless SIM or “smartcard,” that will allow the guest to use their own wireless device in the local country/market/service area in order to avoid international roaming costs that they would normally incur through their wireless service provider for making local or long distance calls as well as access to mobile data services for Internet browsing or other data applications. Moreover, in some embodiments, the loyalty program that includes this service could allow the hotel to activate a guest profile that is linked to the new mobile telephone number associated with the SIM card provided to the guest. In some embodiments, the hotel may allow the guest to use loyalty points to purchase the service, may charge a fee for the service, or provide it on a complimentary basis.

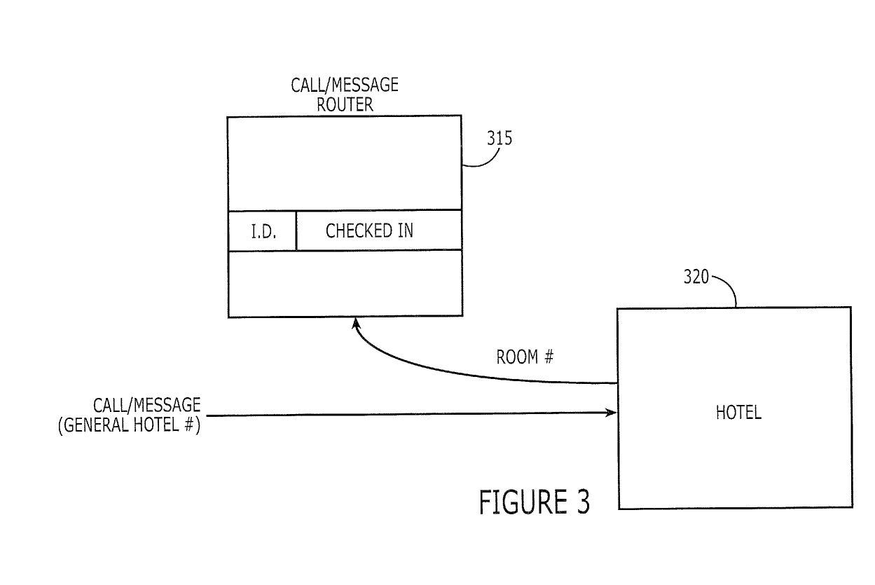

FIG. 3 is a schematic diagram that illustrates calls/message routing directed to the guest checked in to a hotel 320 according to a guest profile 315. According to FIG. 3, the call/message is directed to a general number associated with the hotel 320. The staff at the hotel 320 answers the incoming call and determines that the call is intended for a guest that is checked into a particular room. Accordingly, the staff attempts to connect the call to the particular room in which the guest is staying. However, the routing of the call is actually re-directed using the guest profile 315 (having been activated during the check-in process) so that the call is re-directed to the guest according to the profile, which may actually indicate that the call is to be routed to the guest's mobile phone rather than the terminal in the room. In some embodiments, the call/message router 315 can be maintained by the hotel (i.e., location) while in other embodiments, the call/message router 315 is maintained by a third party.

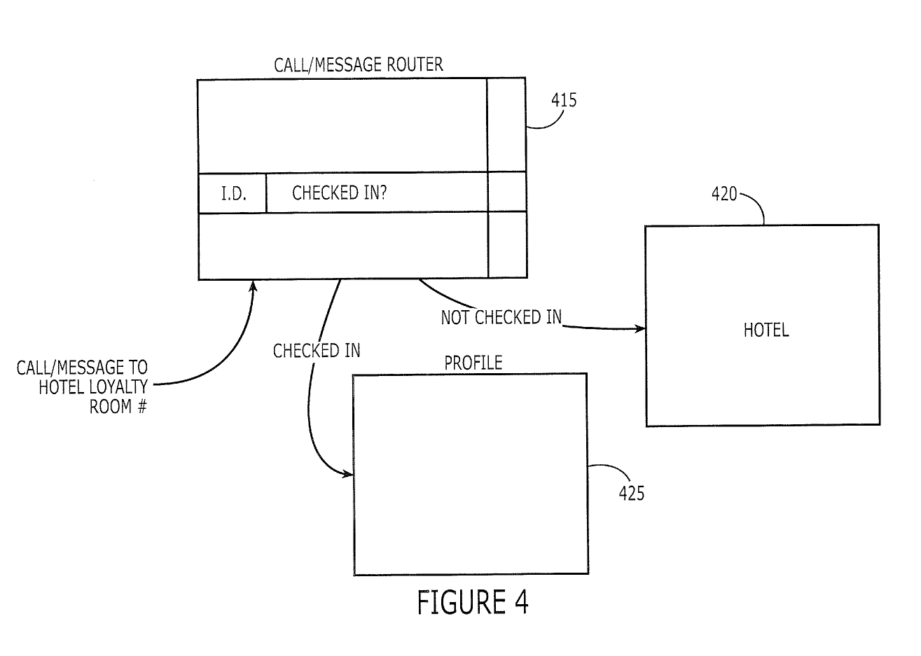

FIG. 4 is block diagram that illustrates routing of calls/messages to a guest in some embodiments. According to FIG. 4, an incoming call/message is directed to a particular room number at a hotel 420 to which the guest is checked in. In this embodiment, the call is routed by a call/message router 415 that has access to the guest profile activated during the check in process (and associated with the identifier for communications with the guest). Accordingly, when the call/message is received by the call/message router, it is determined whether the guest is checked in by comparing the identifier to the room number to which the call is directed. If a match occurs, it is determined whether that guest is currently checked in to the hotel 420. If the guest is not checked in, the call is directed to the staff in the hotel 420, using for example, the general number of the hotel 420. In contrast, if it is determined that the guest is checked into the hotel 420, the call is routed according to a guest profile 425 that is accessed by the call message router 415 using the identifier.

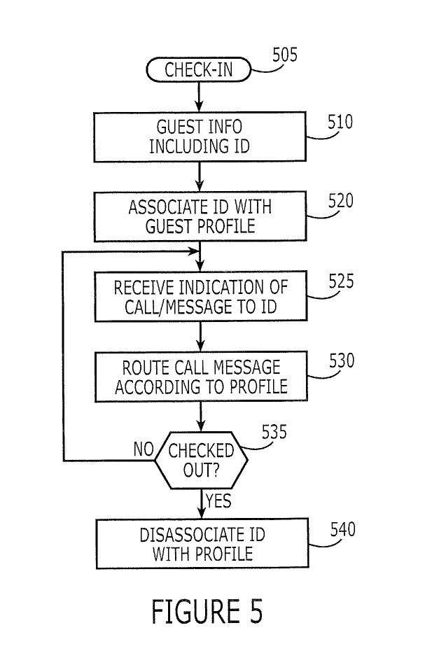

FIG. 5 is a flow chart that illustrates operations according to guest loyalty programs in some embodiments. According to FIG. 5, a guest initially checks into a loyalty location (block 505) whereupon guest information is entered into the loyalty location system including an identifier for communication with the guest while checked in at the location (block 510), such as room number. The identifier for communication assigned to the guest at check in is associated with the guest profile that was initially set up using the loyalty program portal or website (block 520). When an indication of a call/message directed to the identifier is received (block 525), the call/message is routed according to the guest profile (block 530). Routing of calls is handled according to the guest profile as described above in reference to blocks 520-530 until the guest checks out of loyalty location (block 535), whereupon the identifier is disassociated with the guest profile (540).

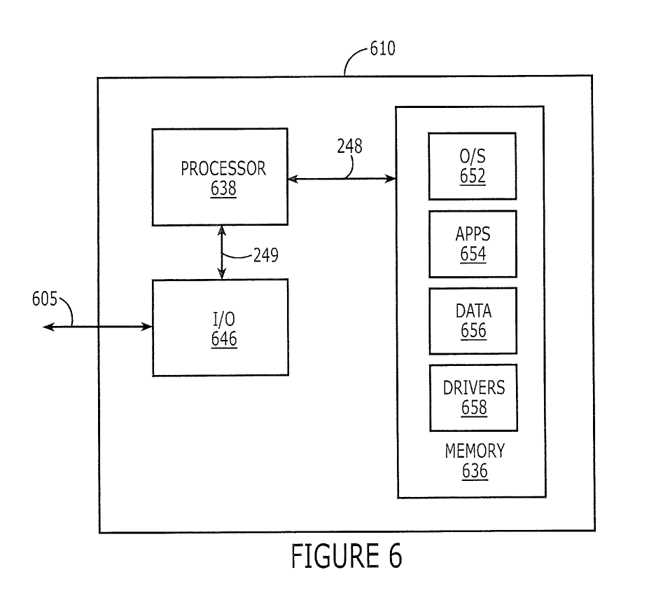

FIG. 6 is a block diagram of an exemplary call/message router 610 configured in some embodiments. As illustrated, the call/message router 610 includes a processor 638, a memory 636 and input/output (I/O) circuits 646. The call/message router 610 may be incorporated in, for example, a general purpose computer, server, or the like. The processor 638 communicates with the memory 636 via an address/data bus 648 and communicates with the input/output circuits 646 via an address/data bus 649.

The call/message router 610 is coupled to a network 605 through the input/output circuits 646 using, for example, an Internet Protocol (IP) connection to receive messages and communications, which may include VOIP type communications described above.

The components in the call/message router 610 may be known components such as those used in many data processing systems, which may be configured to operate as described herein. In particular, the processor 638 can be any commercially available or custom microprocessor, microcontroller, digital signal processor or the like. The memory 636 may include any memory devices containing the software and data used to implement the functionality circuits or modules used in accordance with embodiments described herein. The memory 636 can include, but is not limited to, the following types of devices: cache, ROM, PROM, EPROM, EEPROM, flash memory, SRAM, DRAM and/or magnetic disk.

As further illustrated in FIG. 6, the memory 636 may include several categories of software to provide operation of the call/message router 610: an operating system 652; application programs 654 including the software to provide the operations of the call/message router 610 described herein, translation between different message formats (such as text to voice and voice to text), input/output device drivers 658; and data 656.

In some embodiments, the applications software 654 can convert messages to/from various formats so that the routing of messages may provide more suitable formatting when a message to be routed is not in the “native” format of the device to which the message is to be routed. For example, the system used to route the messages to a device specified in the profile may include a text to voice conversion function that allows the conversion of incoming email messages to audio which can then be forwarded for delivery to a voice based user device, such as a PSTN telephone, a VoIP telephone, voicemail, etc. Furthermore, the system can include software to convert voice based messages to text, such as to convert a voice message to an email message that is forwarded.

The data 656 represents the static and dynamic data used by the application programs 654, the operating system 652, and the input/output device drivers 658, that may reside in the memory 636. The data 56 can include the the different profiles to be used and the profile parameters included therein associated with different locations, etc. as described herein.

As will be appreciated by those of skill in the art, the operating system 652 may be any operating system suitable for use with a data processing system, such as OS/2, AIX or zOS from International Business Machines Corporation, Armonk, N.Y., Windows 95, Windows98, Windows2000 or WindowsXP from Microsoft Corporation, Redmond, Wash., Unix or Linux.

The input/output device drivers 658 typically include software routines accessed through the operating system 652 by the application programs 654 to communicate with devices such as the input/output circuits 646 and the memory 636.

As described herein, in some embodiments users can become members of a loyalty program to set up a guest profile that can be activated upon check-in via a location(s) associated with the loyalty program. The guest profile can specify how communications directed to the guest are to be routed while the guest is checked-in via a particular loyalty location. For example, at one location the guest profile may specify that all calls/messages directed to the guest are to be re-directed to the guest's mobile phone number.

The guest profile can also specify other ways that the guest may be contacted while checked-in. For example, the guest profile may specify that the room number should be tried first, whereupon if the call goes unanswered after a certain number of rings, the call/message is then re-directed to the guest's mobile phone, which if unanswered after a specified number of rings, is redirected to another number or address specified in the guest profile. Accordingly, the guest profile can be used to customize communications for the guest while the guest is checked in at the location. This type of customized communication may improve guest satisfaction which may, in turn, increase the loyalty of the guest to stay more frequently at locations associated with the loyalty program.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A method of routing communications according to a loyalty program comprising:
receiving guest information upon checking-in at a location associated with a loyalty program indicating an identifier for communications to a guest while checked-in via the location; and
associating the identifier for communications to the guest with a guest profile upon receiving the guest information upon checking-in.

2. The method according to claim 1 further comprising:
receiving an indication of a call or message directed to the identifier associated with the guest; and
routing the call or message according to the guest profile.

3. The method of claim 2 wherein the indication comprises a telephone number for a room in which the guest is checked-in and the call or message comprises a call or message directed to the telephone number for the room, wherein the guest profile specifies that the call or message is to be routed to a telephone number associated with the guest, wherein routing comprises:
routing the call or message to the telephone number associated with the guest.

4. The method according to claim 3 wherein routing further comprises:
ringing the telephone number for the room for a specified interval defined by the guest profile; and then
routing the call or message to the telephone number associated with the guest after the specified interval.

5. The method according to claim 3 wherein the telephone number for the room and the telephone number associated with the guest each have respective terminal devices associated therewith, the routing further comprising:
simultaneously ringing the respective devices in response to the call or message; and
routing the call or message to whichever device is answered first.

6. The method according to claim 1 further comprising:
defining the guest profile for handling of calls and/or messages directed to the guest upon checking-in at a location associated with a loyalty program.

7. The method according to claim 1 further comprising:
receiving an indication that the guest is checked-out; and
de-associating the identifier for communications to the guest from the guest profile upon receiving the indication.

8. A system for routing communications according to a loyalty program comprising:
a guest profile comprising a telephone number associated with a guest checked-in via a location associated with the loyalty program; and
a call/message router configured to determine if a call or message directed to the location is associated with the guest checked-in via the location, the call message/router further configured to re-direct the call or message to the telephone number associated with the guest upon determining that the call or message directed to the location is associated with the guest checked-in via the location.

9. The system according to claim 8 wherein the call/message router is further configured to ring a telephone number for a room to which the guest has been checked-in for a specified interval defined by the guest profile and configured to then route the call or message to the telephone number associated with the guest after the specified interval.

10. The system according to claim 9 wherein the telephone number for the room and the telephone number associated with the guest each have respective terminal devices associated therewith, the call/message router being further configured to:
simultaneously ring the respective devices in response to the call or message and configured to route the call or message to whichever device is answered first.

11. The system according to claim 8 wherein call/message router is further configured to:
receive an indication that the guest is no longer checked-in via the location and configured to de-associate the identifier for communications to the guest from the guest profile upon receiving the indication.

12. A computer program product for routing communications according to a loyalty program comprising a computer readable medium having computer readable program code embodied therein, the computer readable program product comprising:
computer readable program code configured to receive guest information upon check-in at a location associated with a loyalty program indicating an identifier for communications to a guest while checked-in via the location; and
computer readable program code configured to associate the identifier for communications to the guest with a guest profile upon receiving the guest information upon check-in.

13. The computer program product according to claim 12 further comprising:
computer readable program code configured to receive an indication of a call or message directed to the identifier associated with the guest; and
computer readable program code configured to route the call or message according to the guest profile.

14. The computer program product of claim 13 wherein the indication comprises a telephone number for a room in which the guest is checked-in and the call or message comprises a call or message directed to the telephone number for the room, wherein the guest profile specifies that the call is to be routed to a telephone number associated with the guest, wherein computer readable program code configured to route comprises:
computer readable program code configured to route the call or message to the telephone number associated with the guest.

15. The computer program product according to claim 14 wherein the computer readable program code configured to route further comprises:
computer readable program code configured to ring the telephone number for the room for a specified interval defined by the guest profile and computer readable program code configured to then route the call or message to the telephone number associated with the guest after the specified interval.

16. The computer program product according to claim 14 wherein the telephone number for the room and the telephone number associated with the guest each have respective terminal devices associated therewith, the computer readable program code configured to route further comprising:
computer readable program code configured to simultaneously ring the respective devices in response to the call or message; and
computer readable program code configured to route the call or message to whichever device is answered first.

17. The computer program product according to claim 12 further comprising:
computer readable program code configured to define the guest profile for handling of calls and/or messages directed to the guest upon checking-in at a location associated with a loyalty program.

18. The computer program product according to claim 12 further comprising:
computer readable program code configured to receive an indication that the guest is checked-out; and
computer readable program code configured to de-associate the identifier for communications to the guest from the guest profile upon receiving the indication.
